(19) United States
(12) Patent Application Publication
(10) Pub. No.: US 2026/0203649 A1
(43) Pub. Date: Jul. 16, 2026

(54) SYSTEMS AND METHODS FOR MINIMIZING HALLUCINATIONS IN CONTENT GENERATED BY LARGE LANGUAGE MODELS

(71) Applicants: Constructor Technology AG, Schaffhausen (CH); Constructor Education and Research Genossenschaft, Schaffhausen (CH)

(72) Inventors: Ilya BAIMETOV, Seattle, WA (US); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 19/021,890

(22) Filed: Jan. 15, 2025

(51) Int. Cl. G06N 20/00; G06Q 50/20

(52) U.S. Cl. CPC G06N 20/00; G06Q 50/20

(57) ABSTRACT

A system receives, via a user interface (UI), an input specification indicating a topic and properties for generating a custom course comprising a plurality of content blocks. For each respective content block of the plurality of content blocks, the system generates, using a machine learning, the respective content block that describes a portion of the topic; prior to generating a subsequent content block of the plurality of content blocks, the system analyzes a set of properties associated with the respective content block to assess whether the respective content block includes information beyond a scope of the topic as indicated in the input specification, in response to determining that the respective content block includes the information, the system modifies the respective content block; and in response to determining that the respective content block after modification does not include the information, the system generates the subsequent content block.

### FIELD OF TECHNOLOGY

The present disclosure relates to the field of machine learning, and, more specifically, to systems and methods for minimizing hallucinations in content generated by large language models.

### BACKGROUND

Large Language Models (LLMs) are powerful tools for generating text based on the input they receive. However, one significant issue that arises when generating large documents is the phenomenon known as "hallucination." Hallucination in LLMs refers to the generation of text that includes unrelated information, vague statements, or inaccurate answers. This occurs because LLMs rely on patterns learned from vast amounts of data, and they do not have a true understanding of the content they produce. Instead, they predict the next word in a sequence based on probabilities derived from their training data. As a result, when tasked with generating extensive text, the models may produce content that seems plausible but is factually incorrect or irrelevant to the topic at hand.

The problem of hallucination is particularly concerning in contexts where accuracy and reliability are crucial, such as in academic writing, legal documents, or medical advice. For instance, an LLM might generate a convincing but incorrect explanation of a scientific concept. This can lead to misinformation and potentially harmful consequences if the generated text is taken at face value.

### SUMMARY

The systems and methods of the present disclosure address the problem of LLM hallucinations when generating large documents, such as course materials or scientific books, or when answering numerous questions that delve deeply into a topic. The system controls this process by automatically checking intermediate results and employing automated prompt engineering. A key component is a knowledge inspector module, which oversees the generation of new course materials (slide by slide, or topic by topic) to ensure that each slide in an LLM-generated course (e.g., in a slide deck format) meets the formal and substantive requirements of a user (e.g., a teacher). The LLM is allowed to proceed to the next topic or subtopic only when the previous one complies with all requirements. This approach prevents LLM hallucinations and enables the generation of large documents more accurately and quickly with minimal human interaction.

The knowledge inspector is a software module that verifies that the output substantively corresponds to the input requirements (e.g., answers actually address human questions without extraneous information added by the LLM) and that the format of the output aligns with the user's and knowledge model's format requirements (topic/subtopic structure). The knowledge inspector checks each topic and only permits the LLM to generate the next topic or subtopic if the checked slides or pages pass its test. If not, it corrects the prompt (hence prompt engineering) to ensure that the LLM generates accurate answers. The knowledge inspector can be implemented as a set of rules or as a separate neural network.

In one exemplary aspect, the techniques described herein relate to a method for generating custom content using machine learning while minimizing content hallucinations, the method including: receiving, via a user interface (UI), an input specification indicating a topic and properties for generating, based on the topic, a custom course including a plurality of content blocks; for each respective content block of the plurality of content blocks: generating, using a machine learning model, the respective content block that describes a portion of the topic; prior to generating a subsequent content block of the plurality of content blocks, analyzing a set of properties associated with the respective content block to assess whether the respective content block includes information beyond a scope of the topic as indicated in the input specification; in response to determining that the respective content block includes the information beyond the scope of the topic, modifying the respective content block; and in response to determining that the respective content block after modification does not include the information beyond the scope of the topic, generating the subsequent content block using the machine learning model; and generating, for display on the UI, the custom course including the plurality of content blocks.

In some aspects, the techniques described herein relate to a method, further including in response to determining that the respective content block includes the information beyond the scope of the topic, generating an alert on the UI including the information and an option to regenerate the respective content block.

In some aspects, the techniques described herein relate to a method, wherein modifying the respective content block includes regenerating the respective content block until the information is not included in the respective content block.

In some aspects, the techniques described herein relate to a method, wherein modifying the respective content block includes removing the information from the respective content block.

In some aspects, the techniques described herein relate to a method, wherein modifying the respective content block includes: updating weights of the machine learning model to prevent inclusion of the information in the respective content block; and regenerating the respective content block using the machine learning model with updated weights.

In some aspects, the techniques described herein relate to a method, wherein the properties in the input specification include one or more of: (1) textual description of the content to generate, (2) external materials to use for content generation, (3) a list of sub-topics in the topic, (4) a desired duration for the custom course, (5) a desired difficulty level of the custom course, and (6) prerequisite concepts of the custom course.

In some aspects, the techniques described herein relate to a method, further including: subsequent to generating the plurality of content blocks, analyzing the plurality of content blocks to assess whether the properties in the input specification are satisfied by respective properties of the each of the plurality of content blocks; and in response to determining that properties are not satisfied by the respective properties, regenerating the plurality of content blocks.

In some aspects, the techniques described herein relate to a method, wherein assessing whether the properties are satisfied by the respective properties includes determining whether any concepts indicated in the properties are omitted by the plurality of content blocks.

In some aspects, the techniques described herein relate to a method, wherein the machine learning model is a large language model.

In some aspects, the techniques described herein relate to a method, wherein the respective content block includes one or more of: text, an audio clip, an image, a video, an interactive element.

It should be noted that the methods described above may be implemented in a system comprising at least one hardware processor and memory. Alternatively, the methods may be implemented using computer executable instructions of a non-transitory computer readable medium.

In some aspects, the techniques described herein relate to a system for generating custom content using machine learning while minimizing content hallucinations, including: at least one memory; and at least one hardware processor coupled with the at least one memory and configured, individually or in combination, to: receive, via a user interface (UI), an input specification indicating a topic and properties for generating, based on the topic, a custom course including a plurality of content blocks; for each respective content block of the plurality of content blocks: generate, using a machine learning model, the respective content block that describes a portion of the topic; prior to generating a subsequent content block of the plurality of content blocks, analyze a set of properties associated with the respective content block to assess whether the respective content block includes information beyond a scope of the topic as indicated in the input specification; in response to determining that the respective content block includes the information beyond the scope of the topic, modify the respective content block; and in response to determining that the respective content block after modification does not include the information beyond the scope of the topic, generate the subsequent content block using the machine learning model; and generate, for display on the UI, the custom course including the plurality of content blocks.

In some aspects, the techniques described herein relate to a non-transitory computer readable medium storing thereon computer executable instructions for generating custom content using machine learning while minimizing content hallucinations, including instructions for: receiving, via a user interface (UI), an input specification indicating a topic and properties for generating, based on the topic, a custom course including a plurality of content blocks; for each respective content block of the plurality of content blocks: generating, using a machine learning model, the respective content block that describes a portion of the topic; prior to generating a subsequent content block of the plurality of content blocks, analyzing a set of properties associated with the respective content block to assess whether the respective content block includes information beyond a scope of the topic as indicated in the input specification; in response to determining that the respective content block includes the information beyond the scope of the topic, modifying the respective content block; and in response to determining that the respective content block after modification does not include the information beyond the scope of the topic, generating the subsequent content block using the machine learning model; and generating, for display on the UI, the custom course including the plurality of content blocks.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for generating custom courses on a user interface (UI) using machine learning and minimizing hallucinations in the custom courses.

FIG. 2 is a diagram illustrating the nested relationship between knowledge, topics, and sub-topics.

FIG. 3 is a diagram illustrating content generation using a knowledge inspector.

FIG. 4 is a diagram illustrating the relationship between content and activity.

FIG. 5 is a diagram illustrating a knowledge browser of a UI.

FIG. 6A is a diagram illustrating a UI accepting a topic selection.

FIG. 6B is a diagram illustrating a UI accepting reference materials for a new topic.

FIG. 7 is a diagram illustrating the UI accepting subtopic selections.

FIG. 8A is a diagram illustrating the UI displaying a generated course.

FIG. 8B is a diagram illustrating the UI displaying an updated course based on a duration input.

FIG. 9 is a diagram illustrating an analysis of the knowledge inspector presented on the UI.

FIG. 10 illustrates a flow diagram of a method for minimizing hallucinations in content generated by large language models.

FIG. 11 presents an example of a general-purpose computer system on which aspects of the present disclosure can be implemented.

### DETAILED DESCRIPTION

Exemplary aspects are described herein in the context of a system, method, and computer program product for minimizing hallucinations in content generated by large language models. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

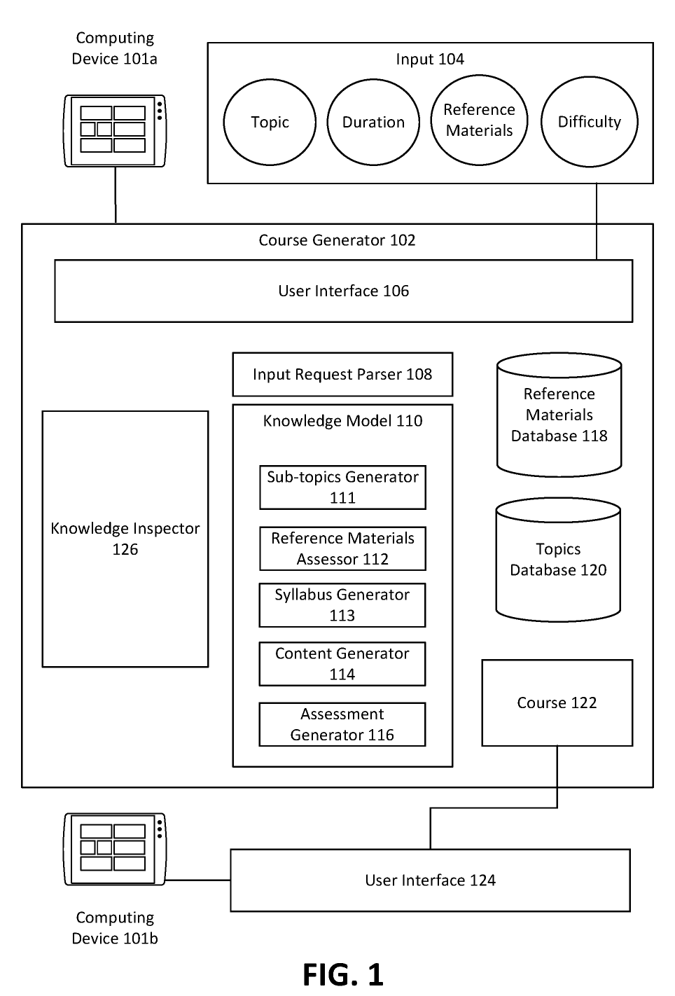

FIG. 1 is a block diagram illustrating a system 100 for generating custom courses on a user interface (UI) using machine learning and minimizing hallucinations in the custom courses. In particular, system 100 features course generator 102, which may be a software installed on or accessed (e.g., via a virtual machine, container, web application) on computing device 101a. Course generator 102 includes a UI 106, input request parser 108, knowledge model 110, reference materials database 118, topics database 120, and knowledge inspector 126. Course generator 102 is configured to generate course 122 for display on UI 106. In some aspects, course generator 102 may transmit course 122 to user interface (UI) 124, which is part of a client application associated with course generator 102. UI 124 may be generated by computing device 101b. For example, computing device 101a may be a device belonging to an educator (e.g., a teacher, a tutor, etc.) and computing device 101b may be a device belonging to a student that is taught by the educator. Alternatively, course 122 may be generated by a student on UI 106 for self-learning.

In some aspects, the UI may be presented via a graphical device (e.g., a graphical user interface), text terminal, chat interface, or internal chat interface by agents or similar, which can receive inputs from a user, or from another ML algorithm generated as a result of its work locally or remotely.

The present disclosure discusses the use of artificial intelligence (AI) (e.g., large language models (LLM)) to create courses for teachers while minimizing hallucinations caused by the AI. For example, a teacher may indicate a topic (e.g., introduction to physics) and duration (e.g., 30 hours) of the course and may provide third party materials (e.g., textbooks, scientific papers, presentations, videos, media, etc.) to include in the course using UI 106. Knowledge model 110 comprising one or more machine learning models (e.g., sub-topics generator 111, reference materials assessor 112, syllabus generator 113, content generator 114, and assessment generator 116) may analyze the user specified sources, as well as other known sources (e.g., stored in reference materials database 118), to generate a syllabus for the course that includes various topics and subtopics. The machine learning module may further fill each lesson of the course with content generated based on the AI analysis of the source materials. All this may be assembled into a book or multiple slide presentations, which serve as the output of the knowledge model 110.

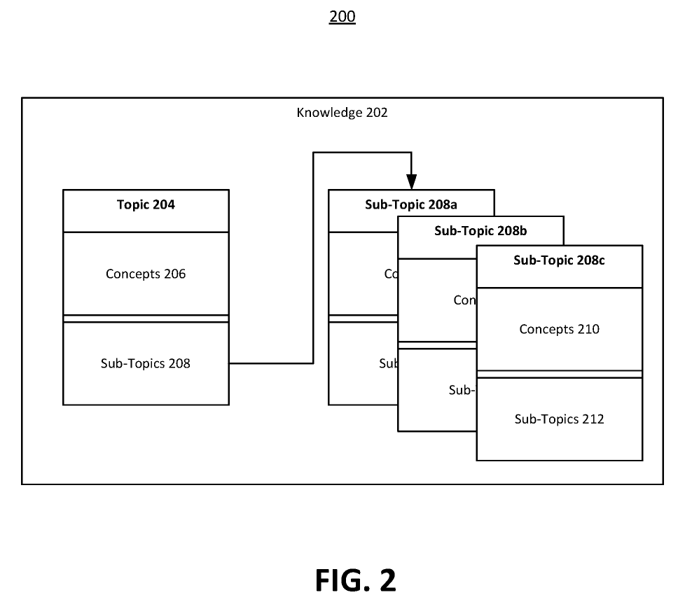

FIG. 2 is a diagram illustrating the nested relationship between knowledge, topics, and sub-topics. Knowledge 202 is organized as nested topics (e.g., topic 204). A topic is a block of knowledge. A minimal topic is usually called a chunk. Topic 204 has a list of concepts 206. A concept is a fundamental idea/principle that underpins the knowledge of the topic. Concepts 206 provide the framework for understanding the subject matter covered by topic 204. For example, a topic “structure of the Solar System” would rely on concepts such as gravity, star, planet, asteroid, comet.

A topic is a recursive structure, which can be made up of sub-topics (e.g., sub-topics 208). For example “astronomy” is a topic that can be further broken down into a sequence of sub-topics such as “formation of the universe”, “stars”, “star galaxies and clusters,” etc. The “stars” sub-topic can be further broken down into “formation of stars,” “types of stars,” “planetary systems,” etc. For example, sub-topic 208 may be broken down to sub-topics 208a, 208b, and 208c. Each of these additional sub-topics have concepts and other sub-topics. For example, sub-topic 208c includes concepts 210 and sub-topics 212.

A topic such as “scientific computing” may include sub-topics “partial differential equations” and “high-performance computing,” where the latter further includes sub-topics “architecture of super-computers” and “HPC software platforms”.

This simple hierarchical structure of topics with corresponding concepts provides a conceptual framework that makes it possible for the human user and other software tools to control the quality and consistency of the material generated by course generator 102. The issue being addressed here is that LLMs can hallucinate, hence there needs to be a way to control, at each level, an amount of knowledge that is included in sub-entities compared to the higher-level specification. More specifically, sub-topics combined under a parent topic should not go beyond the scope of the parent topic. For example, the parent topic “formation of the solar system” should not include a sub-topic “comets outside the solar system” because this clearly goes beyond the topic of “formation.” Likewise, sub-topics combined should not cover more or less the entirety of the parent topic without missing major parts. For example, a topic “components of a car” is assumed to have an “engine” sub-topic, otherwise the knowledge would not be complete.

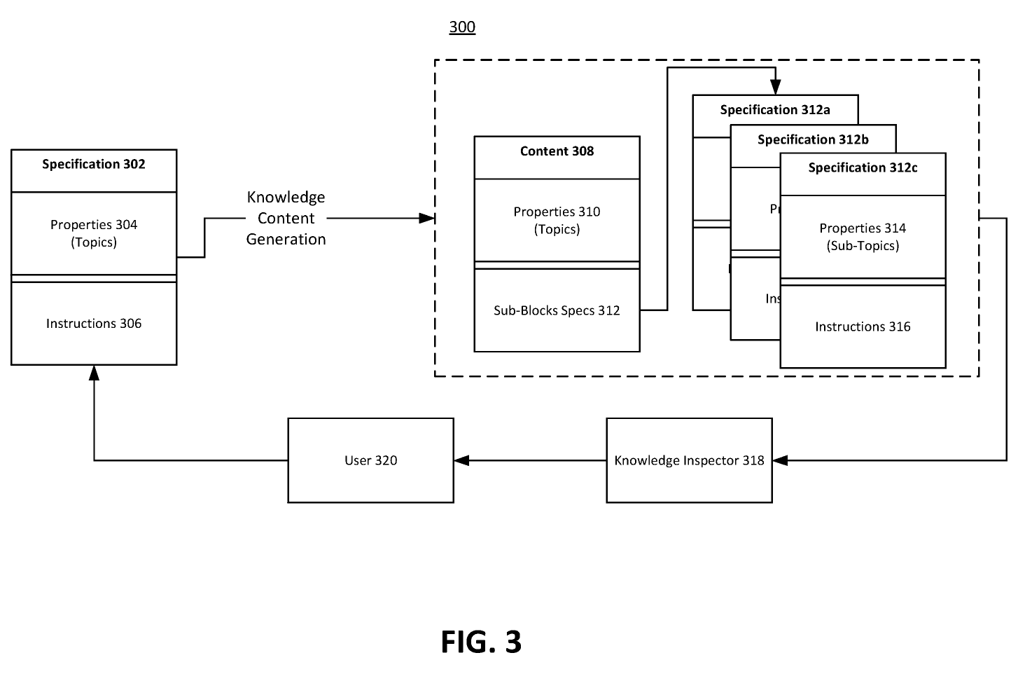

FIG. 3 is a diagram 300 illustrating content generation using a knowledge inspector. The learning content is organized as nested content blocks. A content block can be an atomic content block that has no sub-blocks and is authored and passed around as a single unit (e.g., a static picture or a block of text or even as big as an interactive lecture). The latter is a leaf block because despite having multiple chapters and covering multiple topics, it is still a single content block because it cannot be mechanically broken it into independently usable components.

A content block can also be a composite block that is a sequence of sub-blocks. For example, a self-study content block on “gravity” can include (1) text that explains the concepts of “gravity” and (2) an interactive simulation that allows the learner to do virtual experiments with gravitational system. The text and the simulation are content blocks that can be distributed independently and can be authored by different people and combined into another block by yet another person. Another example of a composite block may be a mid-term exam that includes a sequence of test questions, each being independently authored and distributed via a question bank.

At a high level, a content block (e.g., content 308) is generated from a specification (e.g., specification 302). In some aspects, specification 302 is provided by a user as an input (e.g., input 104). A specification includes some properties (e.g., properties 304) of the desired content and user instructions 306. Examples of properties 304 are:

Name - the name of the property

Description - textual description of the content. Name and Description are the two properties minimally required for generation

References - external materials used for content generation

Topics - list of topics to cover

Intended Learning Outcomes (ILOs) for the course (or program or perhaps a unit of a course) - knowledge that the learners are expected to acquire, expressed in terms of topics and concepts.

Duration - how long the course is (e.g., 1 hour, two weeks, a 14-week semester, etc.).

Difficulty - how advanced the material is

Prerequisites - knowledge that the learners are supposed to have before taking the course (also expressed in terms of topics and concepts).

It should be noted that the set of properties is not limited. Course generator 102 will interpret all the properties and generate the resulting content block.

Instructions 306 may indicate other details such as when the course should be generated by or which sources to gather information from.

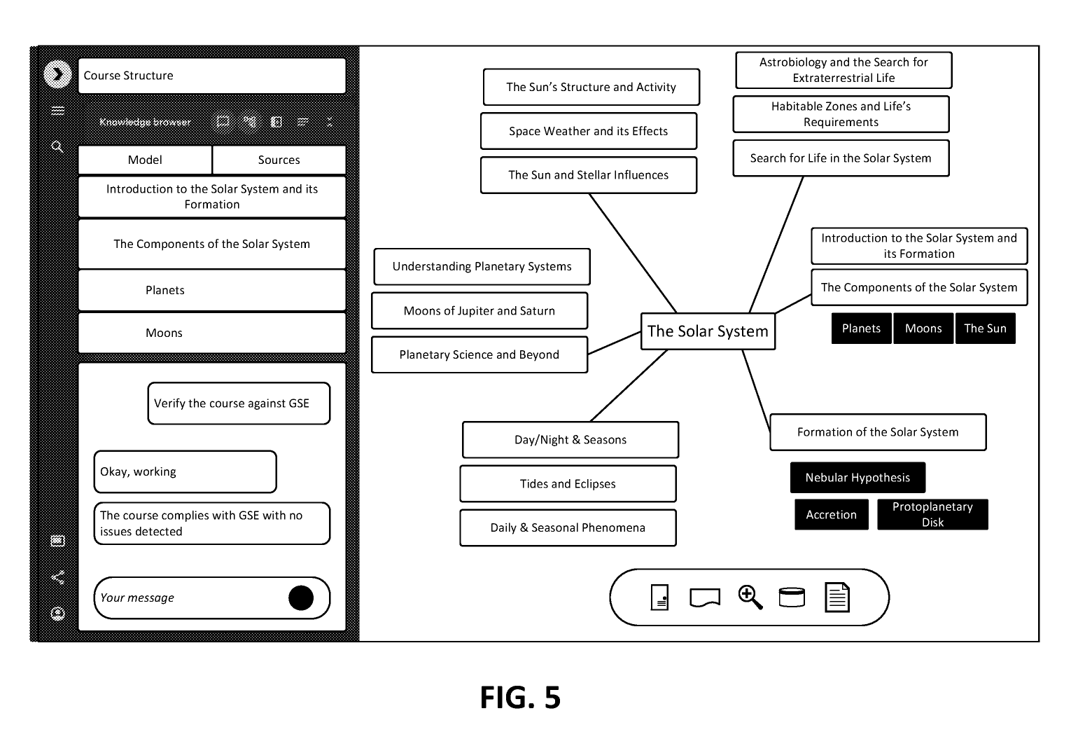

In some aspects, course generator 102 may generate a course where certain topics and concepts can appear as a result of generating a more detailed content. For example, when course generator 102 is asked to generate a course on the “Solar System,” an author can request to cover the topics of “formation of the Solar System” and concepts such as “nebular hypothesis” and “accretion” (see FIG. 5). Course generator 102 will then generate the content for the course with a much longer list of both topics and concepts, which the system will add to the knowledge model 110 of the course.

The relationship between knowledge blocks (topics and concepts) and content blocks is many-to-many. A single content block can cover multiple topics and concepts. At the same time, a single topic or a concepts can be covered by multiple content blocks. Since each content block can be “consumed” independently, there is a 1:1 correspondence between content block structure and activity structure.

When generating content, course generator 102 takes a content specification 302 and generates (1) a content block (e.g., content 308) defined by the specification with properties 310 and (2) specifications 312 for each sub-block. For example, specifications 312a, 312b, and 312c may be for sub-topics of a topic. Each of the specifications 312a, 312b, and 312c may have their own properties and additional instructions. For example, specification 312c comprises properties 314 and instructions 316. Knowledge inspector 318 then verifies the result (i.e., the content block and the specifications for sub-blocks). In some aspects, the results of verification are reviewed by a human user 320 (e.g., a teacher). If the user 320 is not satisfied with the results, he/she can revise the specification 302 and repeat the process. Once the user 320 is satisfied with the result, the process can be recursively applied to the sub-blocks of the block.

Course generator 102 includes a knowledge model 110, which comprises an augmented LLM. In some aspects, the LLM is pre-built (e.g., off-the-shelf LLM such as ChatGPT). In some aspects, the LLM is custom-built for the purpose of generating courses for a specific area of knowledge. The result of generation is a content block, which ncludes a set of properties - usually an extended set, where values of the initial properties could either be preserved or augmented (depending on the model and instructions), and a more comprehensive set of properties (again, depending on the model and instructions).

The generation process works as follows:

The user defines the initial set of properties (e.g., topics, sub-topics, duration, difficulty, etc.) and specifies the initial values for these properties in input 104. Then, the user runs the knowledge model 110 of course generator 102 to generate the content block.

The knowledge model 110 generates (1) updated properties for the content block - possibly augmented and extended, (2) the content of the content block, (3) specification for sub-blocks that are included in the block.

The user can use the newly generated properties to update the specification and re-generate the block until the results are satisfactory. The user can further recursively apply the same content generation process for generating any of the sub-entities of the topic.

As mentioned previously, course generator 102 uses knowledge model 110 to generate content from a spec. A Knowledge Model has the following components:

Knowledge (Knowledge Blocks) - organized into nested topics and corresponding concept. In system 100, knowledge is stored in topics database 120.

Generator – a machine learning model, typically an augmented LLM (RAG, LORA, fine-tuning, memory, etc.) with the main purpose of generating content blocks from a specification. For example, the generator may be a combination of sub-topics generator 111, reference materials assessor 112, syllabus generator 113, content generator 114, and assessment generator 116.

It should be noted that since the generator is based on an LLM, it already implicitly includes knowledge elements required to generate an initial version of the content. As soon as the generator produces the first initial content block from a minimal specification, it will also produce some initial minimal version of the knowledge. This initial version can then be recursively expanded - either fully autonomously or with a human user manually augmenting the generating process. The user can provide additional materials, edit instructions, modify the list of topics and concepts, etc.

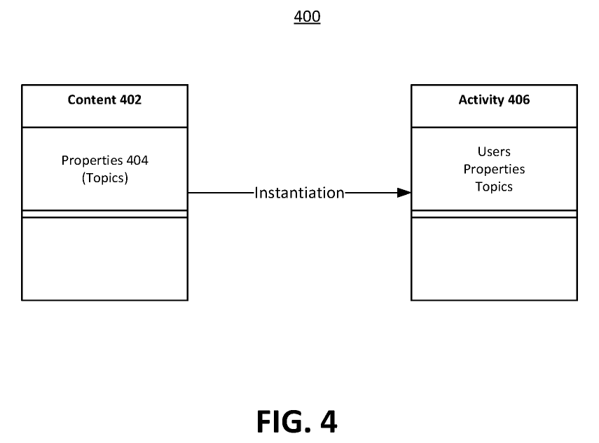

FIG. 4 is a diagram 400 illustrating the relationship between content 402 (comprising properties 404) and activity 406. An activity (e.g., learning activity) is a process of one or more users learning knowledge in a content block. For example, an interactive lecture is a content block. The process of a student going through the lecture is the corresponding activity. A classroom storyboard is a content block. The process of a teacher and students participating in a live class is the corresponding activity. Essentially, an activity is a process of users consuming content, hence, enabling the collection of behavioral metrics and statistics for each participating user. For example, the system 100 may observe how engaged are the students during live class (e.g., how often they raise hands, write to a chat, etc.). The system 100 may measure how long it took for a person to watch a lecture, how many times they rewound, how many times interacted with the avatar, what questions did they ask, etc.

FIG. 5 is a diagram illustrating a knowledge browser of a UI. The knowledge browser enables a user to see a visualization of topics and their related sub-topics (e.g., linked data). The user may further modify the relationships directly on the knowledge browser. For example, if the topic is “the Solar System,” the user may manually add or remove sub-topics such as “the Sun and Stellar Influences.”

Referring to FIG. 1, in some aspects, course generator 102 uses a 3-step generation of the course. First, course generator 102 generates a syllabus, which is a organization scheme providing a course’s structure, using an LLM that receives a description, reference materials, and other instructions from the user. The course structure includes topics, concepts (used interchangeably with sub-topics), and activities (used interchangeably with assessments). Second, course generator 102 enables the user to revise and edit the syllabus. Lastly, course generator 102 generates content for the course (e.g., including learning activities for each sub-topic).

In some aspects, course generator 102 receives, from the user, a description of the course (e.g., one or more of a title, a course syllabus, learning outcomes, duration, and other parameters/criteria). Course generator 102 may also receive, from the user, external source materials for course generation (e.g., books, articles, presentations, lectures, multimedia, etc.). Course generator 102 may even receive, from the user, additional instructions for fine-tuning an LLM of knowledge model 110 such as rules for creation of the course (e.g., paraphrase external materials or use direct quotes, add homework or quiz after each lecture, example of materials that LLM should use to generate the course, but not use in the course, such as user’s old lectures/courses that show the preferred structure of feel of the course, but whose contents should not be used in the new course).

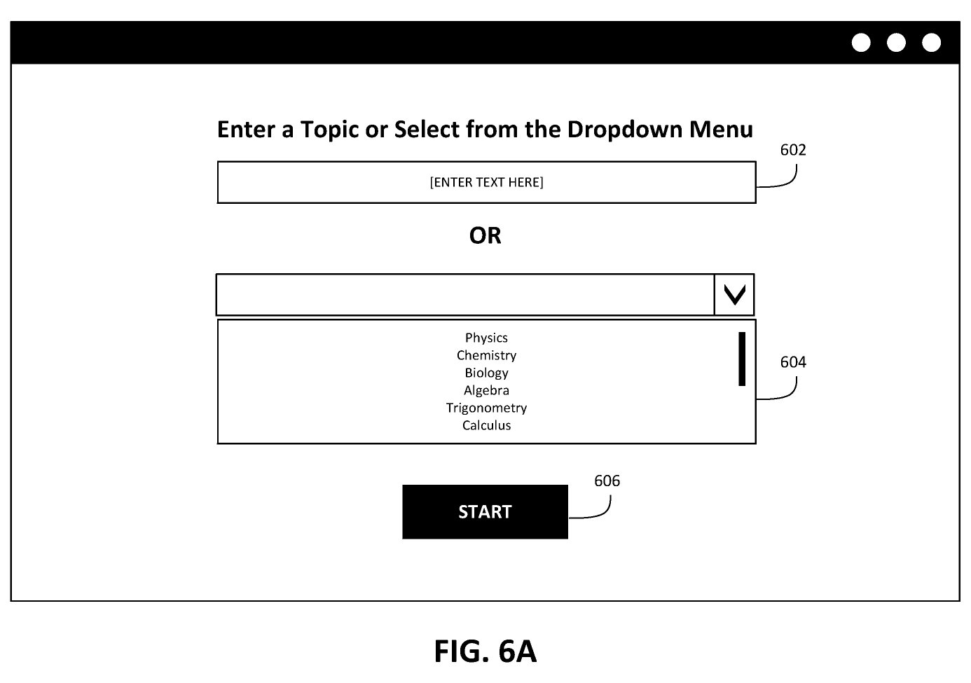

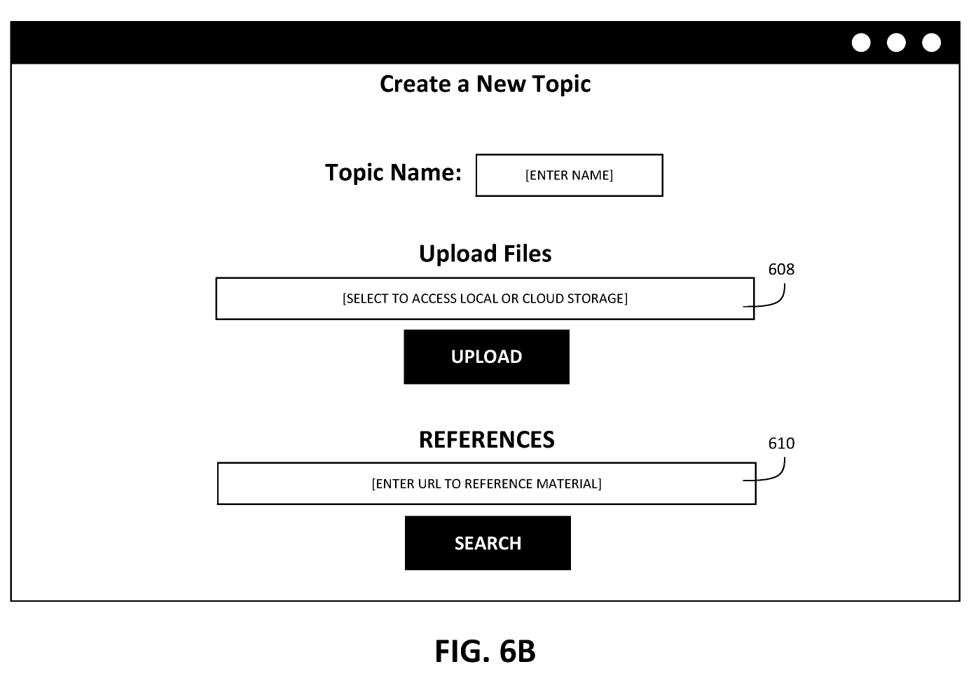

In an exemplary aspect, course generator 102 populates topics database 120. Topics database 120 includes a plurality of topics (e.g., “biology,” “chemistry,” “physics,” etc.), each of which include a plurality of sub-topics. For example, the user may provide a plurality of reference materials to course generator 102. Reference materials include, but are not limited to, textbooks, non-fiction books, webpages, e-books, videos, graphics, research papers, patents, etc. In some aspects, the user may provide, to course generator 102, a copy of the reference material(s) or may provide links to the reference material(s) for course generator 102 to web crawl. The user may label the reference materials as part of a topic. For example, the user may type in a topic in UI 106, and upload reference materials (see FIG. 6B). All provided reference materials are stored in reference materials database 118.

Given a set of reference materials for the topic, knowledge model 110 is configured to identify various sub-topics of the topic. For example, if the topic is “poetry,” a sub-topic may be a particular type of poetry or a famous poet. In order to identify the sub-topics, course generator 102 may refer to the chapter titles of the reference materials (e.g., video names, slide titles, textbook chapter titles, etc.) and identify each unique title as a sub-topic. In another approach, sub-topics generator 111 of knowledge model 110 may be used to execute an algorithm such as Latent Dirichlet Allocation (LDA).

In some aspects, input request parser 108 may clean the provided/linked text data by removing stop words, punctuation, and irrelevant characters. Input request parser 108 may further break down the cleaned text into individual words or tokens. This step prepares the data for analysis on a word level. Sub-topics generator 111 may then create a document term matrix (DTM) that represents the frequency of each term (word) in each document (e.g., textbook, webpage, etc.). Each row of the DTM may correspond to a document, and each column may correspond to a unique term, with the matrix cells including the frequency of each term in the respective document. Sub-topics generator 111 may then apply the LDA algorithm to the DTM. LDA assumes that each document is a mixture of sub-topics, and each sub-topic is a mixture of words. The algorithm iteratively assigns words to sub-topics based on the distribution of topics across documents. Furthermore, sub-topics generator 111 assigns each document a probability distribution over topics, and each word is assigned to a specific sub-topic with a certain probability. Sub-topics generator 111 may identify the most probable sub-topics for each document based on the assigned probabilities. This step involves looking at the words with the highest probability in each sub-topic and interpreting them to label the sub-topics.

Using the method described above, sub-topics generator 111 is able to identify the most common words in each topic/subtopic. Said words are stored in a glossary of the topic, which is further recorded in topics database 120. In particular, the glossary indicates multiple words and a weight of each word. The weight of the word may be determined based on a frequency at which each word appears in the reference materials. For example, for a sub-topic such as “photosynthesis” in the topic “biology,” terms such as “sunlight” and “carbon dioxide,” which appear frequently in relation to “photosynthesis” in the reference materials may be weighted higher than “night,” and “hydrogen,” which appear less frequently. For example, the weight of “sunlight” may be 1.1, while the weight of “night” may be 0.2. This suggests that in a summary, the words with higher weights should be preferred for inclusion than words with lower weights. This may be because less common words are probably specific to one textbook or niche ideas.

Reference materials assessor 112 of knowledge model 110 may also be configured to assign a quality level to each reference material in reference materials database 118. A quality level represents a reliability and general preference of a textbook as expressed in a quantitative value. For example, a university level textbook on “biology” may be a high quality material, where as a fiction novel about “biology” may be a low quality material. Assessing the quality of multiple reference materials using machine learning involves defining and extracting features that represent various aspects of a material’s quality. Reference materials assessor 112 may define objective metrics (e.g., readability scores, grammatical correctness, and the complexity of sentence structures) and subjective metrics (e.g., metrics based on expert reviews, user ratings, or feedback from educators and students) for each reference material. Using these metrics, reference materials assessor 112, which may be a trained classification model, may output a quality level for each reference material. In some aspects, a quality level may be a quantitative value (e.g., a rating out of 10) or a qualitative value (e.g., “low,” “medium,” “high,” etc.).

Reference materials assessor 112 of knowledge model 110 may also be configured to assign a difficulty level to each reference material in reference materials database 118. For example, a university level textbook on “biology” may be a high difficulty material, where as an elementary school textbook about “biology” may be a low difficulty material. Reference materials assessor 112 may define metrics such as complexity of sentence structures, word length, recommended age groups, target grade level, etc., for each reference material. Using these metrics, reference materials assessor 112, which may be a trained classification model, may output a difficulty level for each reference material. In some aspects, a difficulty level may be a quantitative value (e.g., a rating out of 10) or a qualitative value (e.g., “low,” “medium,” “high,” etc.).

Course generator 102 stores reference materials and their respective quality levels and difficulty levels in reference materials database 118. It should be noted that prior to first use of course generator 102 for generating courses, the topics database 120 and reference materials database 118 needs include at least one topic and at least one reference material pertaining to the topic. A developer of course generator 102 may populate the software with multiple topics and reference materials for each topic. Afterwards, users can add topics and reference materials individually. In some aspects, topics database 120 and reference materials database 118 may be synchronized across multiple computing devices running course generator 102. For example, multiple schools or communities may share newly created topics and reference materials over a cloud database. As a result, any of a topic, reference material, course, etc., generated on one computing device may be transmitted by course generator 102 to a different computing device over a network (e.g., a local area network (LAN), a wide area network (WAN), etc.) for display on a GUI.

Suppose that a user launches course generator 102 on computing device 101a to generate a course 122 on UI 106. In an exemplary aspect, UI 106 receives input 104, which may include a topic and, in some aspects, any of a duration, a difficulty, and preferred reference materials. For example, the topic in input 104 may be “biology.” Input request parser 108 may search for the topic in topics database 120. In response to finding a match, course generator 102 may output course 122 on UI 106.

A course has several means of configuration including, but not limited to, the selection of topic, selection of sub-topics, selection of reference materials, selection of duration, selection of difficulty, glossary customization, etc. In some aspects, some configurations may be set on a course level (e.g., a duration or difficulty of an entire course) and some configurations may be set on a sub-topic level (e.g., a duration of a particular lesson on a sub-topic). In response to receiving a generic input (e.g., “biology”), course generator 102 may generate course 122 using default configurations (e.g., a default set of sub-topics, difficulty, duration, etc.). In some aspects, the default configurations may be set by course generator 102 based on user preferences. For example, when creating a user profile, the user may indicate that he/she is in the 12^{th} grade. Based on this information, course generator 102 may set the difficulty of a course to “high school” level, may set the duration to 170 hours (accounting for an hour per school day), and may use high school textbooks to generate course content.

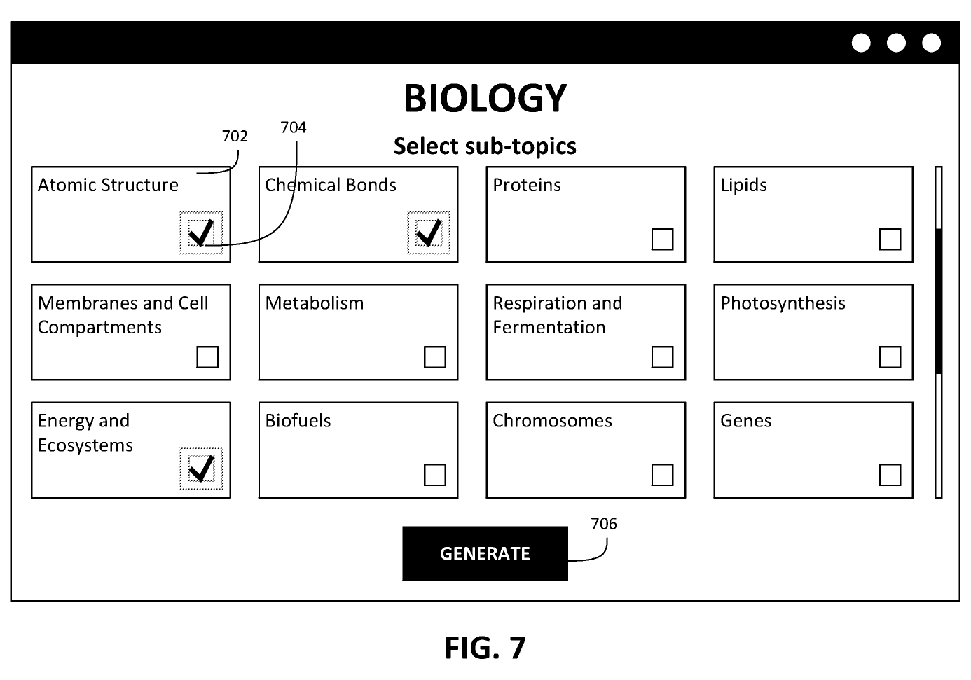

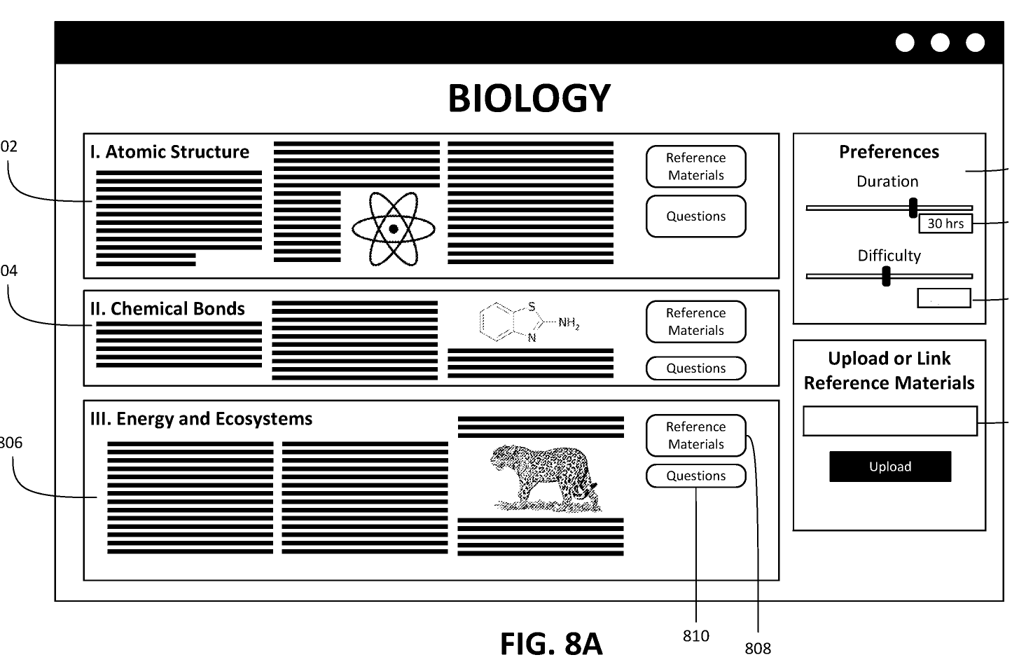

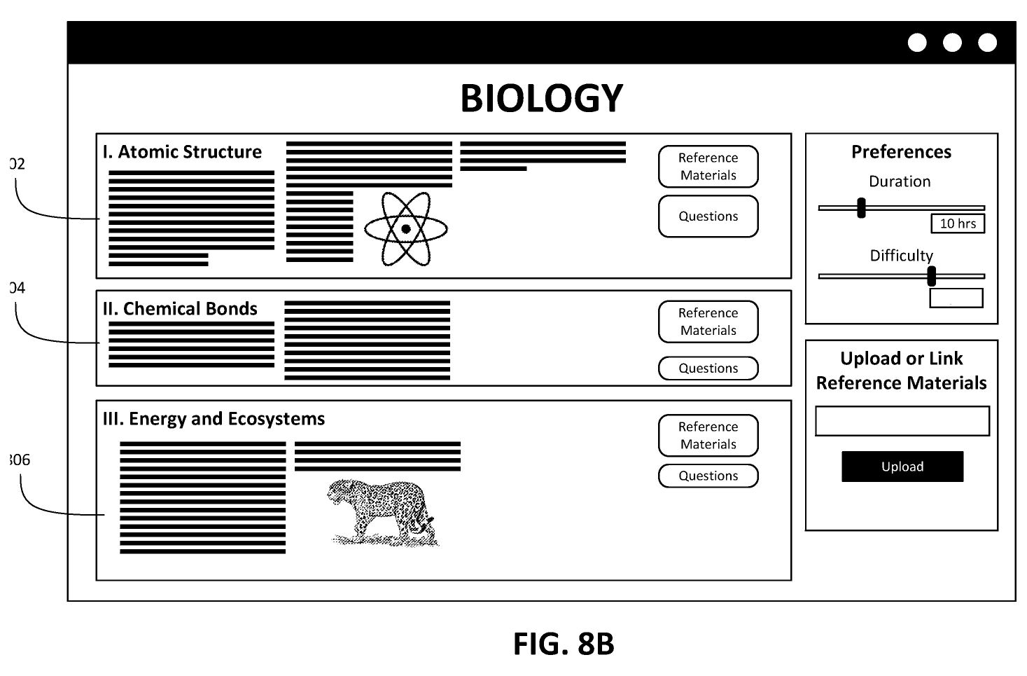

In some aspects, course generator 102 may generate queries on UI 106 to acquire more preferences by the user. For example, course generator 102 may generate a prompt that requests the user to select the sub-topics of interest (see FIG. 7). Course generator 102 may also generate panels that include configuration options (see FIG. 8A). For example, a user may be able to adjust the difficulty or duration of a course, while course generator 102 adjusts the content generated for a particular sub-topic.

In terms of course generation, syllabus generator 113 is configured to generate a structure of the course. Based on the selection of a topic, sub-topics, duration, difficulty, reference materials, etc., syllabus generator 113 outputs a plurality of course attributes. For example, the course attributes may indicate that the course has three sub-topics to be covered over nine hours on an intermediate difficulty. To achieve a nine hour duration, syllabus generator 113 allocates three hours for each sub-topic. To achieve three hours for each sub-topic, syllabus generator 113 limits a word limit of the content to 24000 (accounting for 200 word per minute reading speed), an assessment limit of 20 questions, and a media limit (e.g., a video) of 20 minutes. To achieve the difficulty constraints, reference materials matching the difficulty level are specified. For simplicity, all of these configurations are kept the same for each sub-topic in this example. However, a user may specify sub-topic level preferences, which may change these numbers. Furthermore, word limits may change based on the difficulty level as well as both duration and difficulty may affect each other. For example, at an elementary school level, the reading speed is significantly slower and comprehension skills are lower than at a university level. Accordingly, syllabus generator 113 may output lower word limits to accommodate.

In order to produce accurate structures, knowledge model 110 trains syllabus generator 113, which may be a regression model, using a training dataset that includes several input vectors and corresponding output vectors. The input vectors may each include user preference fields such as topic, sub-topic count, duration, difficulty, sub-topic level preferences, etc. The corresponding output vectors may each include course attribute fields with the ideal word limits, media limits, question limits, etc., per sub-topic. By training syllabus generator 113 to generate the output vectors based on the input vectors, syllabus generator 113 is able to recommend a plurality of course attributes for any set of course configurations provided in input 104.

Content generator 114 receives the course attributes and generates content for each sub-topic. In particular, the content comprises a summary, graphics, media, assessments (e.g., questions, projects, etc.), and recommended supplemental readings generated using one or more reference materials.

Generating summaries from multiple reference materials in reference materials database 118 using machine learning involves leveraging natural language processing (NLP) and text summarization techniques. In an exemplary aspect, content generator 114 may perform tokenization on each of the reference materials above a threshold quality level and that match a difficulty level preferred/specified by the user. Content generator 114 converts the tokenized text into numerical representations using techniques like Term Frequency-Inverse Document Frequency (TF-IDF) or word embeddings (e.g., Word2Vec, GloVe). This step captures the semantic meaning of words. In some aspects, content generator 114 may employ one or both of abstractive and extractive summarization approaches. Abstractive summarization involves generating new sentences to convey the summary, while extractive summarization selects and rearranges existing sentences.

In a supervised learning approach, content generator 114 is trained on labeled data with summaries corresponding to the reference materials. Accordingly, content generator 114 learns the relationship between the content and its corresponding summary. In an unsupervised learning approach, content generator 114 may use graph-based methods (e.g., TextRank) or clustering algorithms to identify and select the most important sentences. The length of the summary is bound to the course attribute indicated by syllabus generator 113. For example, if the word limit is 24000, the summary will include sentences extracted and/or abstracted from the reference materials that include no more than 24000 words. Because the reference materials are filtered based on quality and difficulty, content generator 114 generates tailored summaries for the user.

In an exemplary aspect, when selecting the sentences to include in the summary, content generator 114 refers to the glossary in topics database 120 – specifically the glossary terms corresponding to a particular sub-topic. The weights of the words indicate which words are more important than others. Thus, the sentences extracted from reference material are likely to include words with higher weights. Likewise, self-generated sentences are likely to include words with higher weights. In some aspects, a user may access the glossary and adjust weights. In fact, a user may opt to add words and remove words depending on their learning preferences.

In some aspects, the extracted sentences from the reference materials may include mentions of graphics. For example, a textbook passage may refer to a textbook image. Accordingly, content generator 114 includes the mentioned graphic in the generated content. In another example, a website may include a link to a video on a video streaming website. Accordingly, content generator 114 includes the link to the video in the generated content.

Assessment generator 116 is configured to generate one or more of questions, short quizzes, tests, lab projects, etc., based on the generated content. For example, assessment generator 116 may be a generative neural network that receives the summary generated by content generator 114 and creates questions with answers found in the summary. If the summary says “the mitochondria is an organelle in which respiration and energy production occur,” assessment generator 116 may generate the question “which organelle is responsible for respiration and energy production?”. In some aspects, assessment generator 116 may identify questions found in the reference materials associated with the sub-topic. For example, if the summary includes information about the mitochondria, assessment generator 116 may identify a question in the reference material about the mitochondria. In some aspects, assessment generator 116 compares the sentences in the summary to the sentences in the questions. Based on a correspondence, assessment generator 116 determines whether the question is a candidate for inclusion in the generated content. It should be noted that the number of questions or types of assessments produced by assessment generator 116 is indicated in the course attributes generated by syllabus generator 113.

FIG. 6A is a diagram illustrating a UI accepting a topic selection. The UI in FIG. 6A corresponds to UI 106 generated on computing device 101a. UI 106 (as shown in FIG. 6A) displays text stating “enter a topic or select from the dropdown menu” and provides two input options right below. UI 106 may receive a text input in textbox 602 (e.g., the user may enter the text “Biology”) or may receive a selection from the plurality of topics listed in menu 604 (e.g., the user may scroll through the menu and select “Biology”). UI 106 receives confirmation of the selection via the selection of the “start” button 606.

FIG. 6B is a diagram illustrating a UI accepting reference materials for a new topic. UI 106 (as shown in FIG. 6B) displays text stating “create a new topic,” and provides field 608 where a user may upload reference materials. For example, UI 106 may receive a collection of slide deck(s), text document(s), graphic(s), etc., that are uploaded by the user from a local storage (e.g., a local hard drive) or a cloud storage (e.g., an online data storage service). Additionally or alternatively, the user may provide Internet-based links (e.g., URL) to said references via field 610.

FIG. 7 is a diagram illustrating the UI accepting subtopic selections. UI 106 (as shown in FIG. 7) generates a plurality of sub-topics to include from the selected topic. For example, if UI 106 receives a selection of “biology,” reference materials assessor 112 may extract the corresponding sub-topics from topics database 120. In FIG. 7, examples of sub-topics include “atomic structure,” “chemical bonds,” “proteins,” “lipids,” etc. Each sub-topic may be listed in a dropdown menu or as a table with multiple selectable elements. For example, in FIG. 7, UI 106 presents the sub-topics as elements such as element 702 that includes a selection indicator 704. When the user selects a selection indicator 704 for a particular element, a graphic indicative of selection may be generated (e.g., a checkmark in the checkbox). After the user is satisfied with his/her selection(s), the user may select the “generate” button 706 to confirm the selection.

FIG. 8A is a diagram illustrating the UI displaying a generated course. Subsequent to receiving selections of the topic and sub-topic, UI 106 generates a course that includes an initial syllabus and initial course content. For example, factors such as duration and difficulty may be default values such as 30 hours and 5/10, respectively. As shown in FIG. 8A, UI 106 displays panels 802, 804, and 806. Each panel is ordered in the manner indicated by the generated syllabus (e.g., “atomic structure,” followed by “chemical bonds,” followed by “energy and ecosystems”). Each panel includes course content, which includes any combination of text, graphics (e.g., images, videos, animations, etc.), interactive plug-ins (e.g., games, etc.), etc., extracted from the reference materials associated with the sub-topics. Each panel further includes reference materials button 808, which allows a user to access the reference materials directly, and may indicate the portions that the user is recommended to read/view/listen to in the reference materials. For example, the user may review panel 806, which includes the course content generated by content generator 114. The user may then select reference materials button 808, which directs the user to a website that includes recommended supplemental material to learn more about the sub-topic. Likewise, UI 106 may receive a selection of questions button 810, which results in an output of questions generated by assessment generator 116.

In an exemplary aspect, UI 106 displays preferences panel 812, which allows the user to customize the course displayed on UI 106. For example, a user may adjust the duration associated with the course by entering a duration value in duration adjuster 814 (e.g., the user may enter a text input or slide the slider). The user may also adjust the difficulty of the course by entering a difficulty value in difficulty adjuster 816. The effects of changing course duration are seen by comparing FIG. 8A and FIG. 8B.

Lastly, the user may upload the reference material that he/she would like to incorporate in the content generated by content generator 114. For example, the user upload a slide deck via panel 818. Accordingly, the text, graphics, etc., shown in the panels 802, 804, and 806 may dynamically change to incorporate the contents of the uploaded slide deck. Similarly, the user may provide an Internet-based link to the reference material via panel 818.

FIG. 8B is a diagram illustrating the UI displaying an updated course based on a duration input. As shown in FIG. 8A, UI 106 displays the course comprising panels 802, 804, 806, and options for each panel via buttons such as buttons 808 and 810. As the user makes adjustments to the course using panels 812 and 818, UI 106 is dynamically updated. In particular, data that is not relevant or does not accommodate the user’s preferences is automatically hidden, whereas data that is relevant and accommodates the user’s preferences is highlighted. In FIG. 8A, the duration of the course is set to 30 hours. In FIG. 8B, UI 106 receives an adjustment that sets the duration to 10 hours. Accordingly, UI 106 dynamically updates such that fewer text is shown. More specifically, the content from the references materials is summarized in a manner that fewer words are used to describe the sub-topic, fewer questions are included in assessments, and not as many reference materials are recommended. As a result, the user spends less time learning the information.

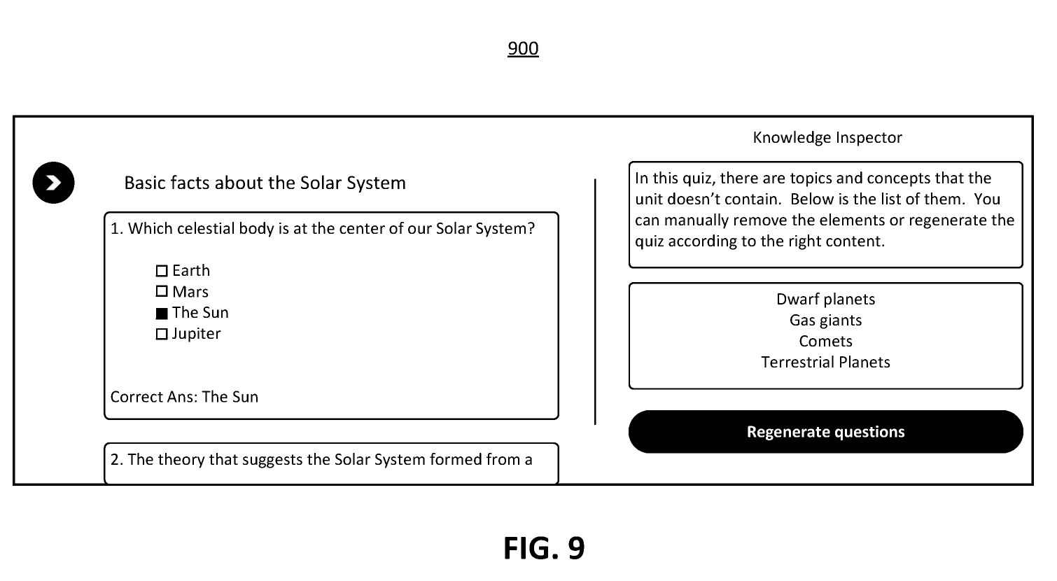

FIG. 9 is a diagram 900 illustrating an analysis of the knowledge inspector presented on the UI. For example, course generator 102 may generate a quiz that includes several multiple-choice questions. Knowledge inspector 126 may analyze the quiz and determine whether it meets the criteria indicated in the properties of the associated topics/sub-topics. For example, the quiz may cover concepts such as “the components of the solar system” and “historical models of the solar system.” However, certain sub-topics such as “dwarf plants, gas giants, comets, terrestrial planets,” and “geocentric model” may be tested in the quiz despite being beyond the scope of the concepts. Knowledge inspector 126 may scan the words in the quiz, detect the concepts being tested, and then highlight the concepts that are unrelated to the topic/sub-topic that the quiz is intended to test. In some aspects, knowledge inspector 126 may automatically regenerate new questions for the quiz. In other aspects, knowledge inspector 126 may provide the user with a result on the UI, as shown in FIG. 9.

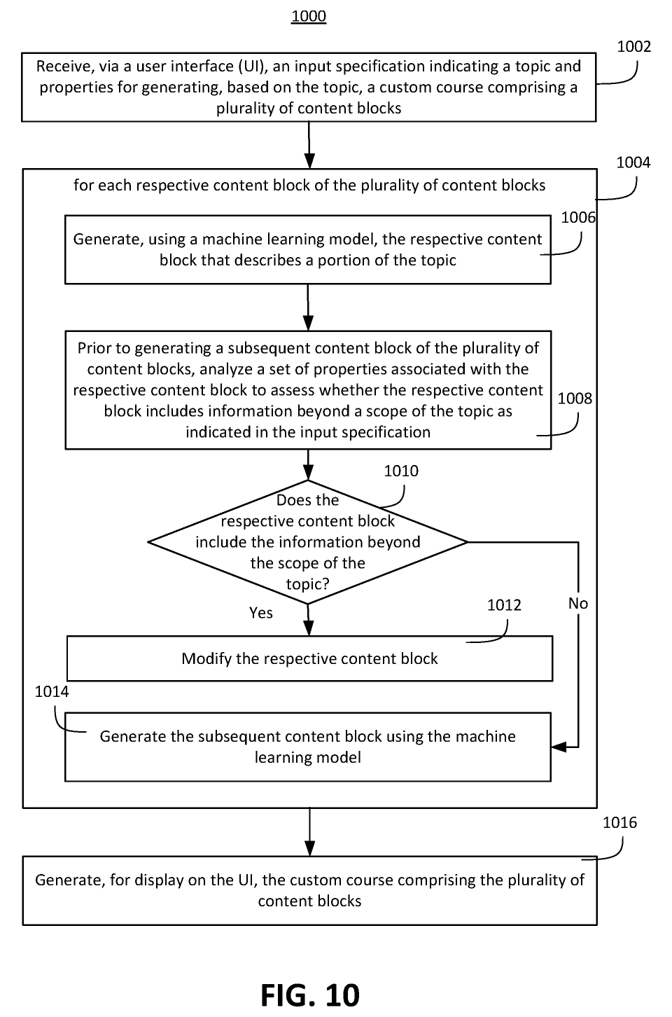

FIG. 10 illustrates a flow diagram of method 1000 for minimizing hallucinations in content generated by large language models. At 1002, course generator 102 receives, via a UI (e.g., UI 106), an input specification (e.g., specification 302, which may be comprised in input 104) indicating a topic and properties (e.g., 304) for generating, based on the topic, a custom course comprising a plurality of content blocks. In some aspects, the properties in the input specification include one or more of: (1) textual description of the content to generate, (2) external materials to use for content generation, (3) a list of sub-topics in the topic, (4) a desired duration for the custom course, (5) a desired difficulty level of the custom course, and (6) prerequisite concepts of the custom course.

Step 1004 comprises steps 1006-1014 and represents the actions performed by course generator 102 for each respective content block of the plurality of content blocks.

For example, at 1006, course generator 102 generates, using a machine learning model (e.g., a large language model such as knowledge model 110), the respective content block that describes a portion of the topic. The respective content block may include one or more of text, an audio clip, an image, a video, an interactive element.

At 1008, prior to generating a subsequent content block of the plurality of content blocks, course generator 102 analyzes a set of properties associated with the respective content block to assess whether the respective content block includes information beyond a scope of the topic as indicated in the input specification.

At 1010, course generator 102 (specifically knowledge inspector 126) determines whether the respective content block includes the information beyond the scope of the topic. This determination involves evaluating the semantic relevance of the content block against the input specification, which outlines the boundaries of the topic. The machine learning model may utilize natural language processing techniques to assess the coherence and relevance of the text, while also employing image recognition algorithms for visual content, and audio analysis for sound clips. Additionally, metadata associated with videos and interactive elements is analyzed to ensure alignment with the topic's scope. By integrating these advanced analytical techniques, the course generator ensures that each content block remains focused and pertinent, effectively filtering out any extraneous information that does not conform to the specified parameters of the topic.

Consider a course generator 102 tasked with creating educational content about renewable energy sources. The input specification defines the scope to include solar energy. As the course generator produces a content block on solar energy, it uses a large language model to generate text, images, and videos that explain photovoltaic cells and their applications. Before proceeding to the next content block, the course generator analyzes the current block's properties. It employs natural language processing to ensure the text strictly pertains to solar energy, while image recognition algorithms verify that any visual content depicts solar panels or related technology. Audio clips are analyzed to confirm discussions are limited to solar energy topics. If knowledge inspector 126 determines that the content block is describing nuclear energy based on the analysis, then the content block is determined to include information beyond the scope of the topic.

In response to determining that the respective content block after modification includes the information beyond the scope of the topic, method 1000 advances to 1012, where course generator 102 modifies the respective content block. For example, course generator 102 may keep regenerating the respective content block until the information is not included in the respective content block. In another example, course generator 102 may remove the information from the respective content block.

In some aspects, the modification involves course generator 102 updating weights of the machine learning model to prevent inclusion of the information in the respective content block, and then regenerating the respective content block using the machine learning model with updated weights.

In some aspects, in response to determining that the respective content block includes the information beyond the scope of the topic, course generator 102 further generates an alert on the UI comprising the information and an option to regenerate the respective content block.

At 1010, in response to determining that the respective content block after modification does not include the information beyond the scope of the topic, method 1000 advances to 1014, where course generator 102 generates the subsequent content block using the machine learning model.

At 1016, course generator 102 generates, for display on the UI, the custom course comprising the plurality of content blocks.

In some aspects, subsequent to generating the plurality of content blocks, course generator 102 analyzes the plurality of content blocks to assess whether the properties in the input specification are satisfied by respective properties of the each of the plurality of content blocks. In response to determining that properties are not satisfied by the respective properties, course generator 102 regenerates the plurality of content blocks. For example, course generator 102 may assess whether the properties are satisfied by the respective properties by determining whether any concepts indicated in the properties are omitted by the plurality of content blocks.

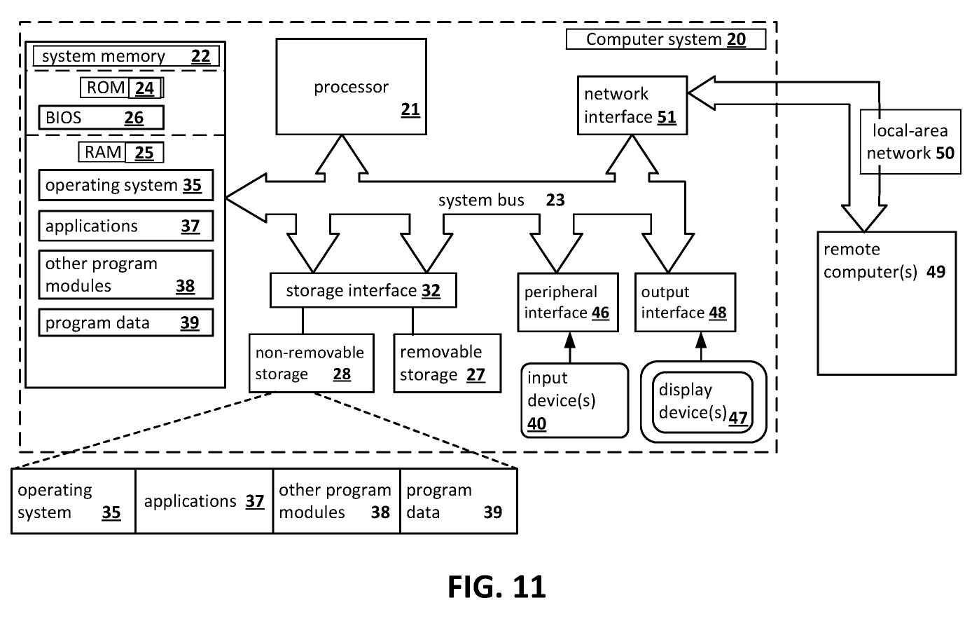

FIG. 11 is a block diagram illustrating a computer system 20 on which aspects of systems and methods for minimizing hallucinations in content generated by large language models may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-10 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22 , removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term "module" as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module’s functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer’s specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for generating custom content using machine learning while minimizing content hallucinations, the method comprising:
receiving, via a user interface (UI), an input specification indicating a topic and properties for generating, based on the topic, a custom course comprising a plurality of content blocks;
for each respective content block of the plurality of content blocks:
generating, using a machine learning model, the respective content block that describes a portion of the topic;
prior to generating a subsequent content block of the plurality of content blocks, analyzing a set of properties associated with the respective content block to assess whether the respective content block includes information beyond a scope of the topic as indicated in the input specification;
in response to determining that the respective content block includes the information beyond the scope of the topic, modifying the respective content block; and
in response to determining that the respective content block after modification does not include the information beyond the scope of the topic, generating the subsequent content block using the machine learning model; and
generating, for display on the UI, the custom course comprising the plurality of content blocks.

2. The method of claim 1, further comprising in response to determining that the respective content block includes the information beyond the scope of the topic, generating an alert on the UI comprising the information and an option to regenerate the respective content block.

3. The method of claim 1, wherein modifying the respective content block comprises regenerating the respective content block until the information is not included in the respective content block.

4. The method of claim 1, wherein modifying the respective content block comprises removing the information from the respective content block.

5. The method of claim 1, wherein modifying the respective content block comprises:
updating weights of the machine learning model to prevent inclusion of the information in the respective content block; and
regenerating the respective content block using the machine learning model with updated weights.

6. The method of claim 1, wherein the properties in the input specification include one or more of:
(1) textual description of the content to generate,
(2) external materials to use for content generation,
(3) a list of sub-topics in the topic,
(4) a desired duration for the custom course,
(5) a desired difficulty level of the custom course, and
(6) prerequisite concepts of the custom course.

7. The method of claim 1, further comprising:
subsequent to generating the plurality of content blocks, analyzing the plurality of content blocks to assess whether the properties in the input specification are satisfied by respective properties of the each of the plurality of content blocks; and
in response to determining that properties are not satisfied by the respective properties, regenerating the plurality of content blocks.

8. The method of claim 7, wherein assessing whether the properties are satisfied by the respective properties comprises determining whether any concepts indicated in the properties are omitted by the plurality of content blocks.

9. The method of claim 1, wherein the machine learning model is a large language model.

10. The method of claim 1, wherein the respective content block comprises one or more of: text, an audio clip, an image, a video, an interactive element.

11. A system for generating custom content using machine learning while minimizing content hallucinations, comprising:
at least one memory; and
at least one hardware processor coupled with the at least one memory and configured, individually or in combination, to:
receive, via a user interface (UI), an input specification indicating a topic and properties for generating, based on the topic, a custom course comprising a plurality of content blocks;
for each respective content block of the plurality of content blocks:
generate, using a machine learning model, the respective content block that describes a portion of the topic;
prior to generating a subsequent content block of the plurality of content blocks, analyze a set of properties associated with the respective content block to assess whether the respective content block includes information beyond a scope of the topic as indicated in the input specification;
in response to determining that the respective content block includes the information beyond the scope of the topic, modify the respective content block; and
in response to determining that the respective content block after modification does not include the information beyond the scope of the topic, generate the subsequent content block using the machine learning model; and
generate, for display on the UI, the custom course comprising the plurality of content blocks.

12. The system of claim 11, wherein the at least one hardware processor is further configured to, in response to determining that the respective content block includes the information beyond the scope of the topic, generate an alert on the UI comprising the information and an option to regenerate the respective content block.

13. The system of claim 11, wherein the at least one hardware processor is further configured to modify the respective content block by regenerating the respective content block until the information is not included in the respective content block.

14. The system of claim 11, wherein the at least one hardware processor is further configured to modifying the respective content block by removing the information from the respective content block.

15. The system of claim 11, wherein the at least one hardware processor is further configured to modify the respective content block by:
updating weights of the machine learning model to prevent inclusion of the information in the respective content block; and
regenerating the respective content block using the machine learning model with updated weights.

16. The system of claim 11, wherein the properties in the input specification include one or more of:
(1) textual description of the content to generate,
(2) external materials to use for content generation,
(3) a list of sub-topics in the topic,
(4) a desired duration for the custom course,
(5) a desired difficulty level of the custom course, and
(6) prerequisite concepts of the custom course.

17. The system of claim 11, wherein the at least one hardware processor is further configured to:
subsequent to generating the plurality of content blocks, analyze the plurality of content blocks to assess whether the properties in the input specification are satisfied by respective properties of the each of the plurality of content blocks; and
in response to determining that properties are not satisfied by the respective properties, regenerate the plurality of content blocks.

18. The system of claim 17, wherein the at least one hardware processor is further configured to assess whether the properties are satisfied by the respective properties by determining whether any concepts indicated in the properties are omitted by the plurality of content blocks.

19. The system of claim 11, wherein the machine learning model is a large language model.

20. A non-transitory computer readable medium storing thereon computer executable instructions for generating custom content using machine learning while minimizing content hallucinations, including instructions for:
receiving, via a user interface (UI), an input specification indicating a topic and properties for generating, based on the topic, a custom course comprising a plurality of content blocks;
for each respective content block of the plurality of content blocks:
generating, using a machine learning model, the respective content block that describes a portion of the topic;
prior to generating a subsequent content block of the plurality of content blocks, analyzing a set of properties associated with the respective content block to assess whether the respective content block includes information beyond a scope of the topic as indicated in the input specification;
in response to determining that the respective content block includes the information beyond the scope of the topic, modifying the respective content block; and
in response to determining that the respective content block after modification does not include the information beyond the scope of the topic, generating the subsequent content block using the machine learning model; and
generating, for display on the UI, the custom course comprising the plurality of content blocks.
